(19) United States
(12) Patent Application Publication
(10) Pub. No.: US 2016/0337702 A1
(43) Pub. Date: Nov. 17, 2016

(54) METHODS AND SYSTEMS FOR RECOMMENDING SUPPLEMENTAL MEDIA ASSETS BASED ON RECENTLY MENTIONED MEDIA REFERENCES

(71) Applicant: Rovi Guides, Inc., Santa Clara, CA (US)

(72) Inventors: Walter R. Klappert, Los Angeles, CA (US); Marine Chimayan, Valley Village, CA (US)

(73) Assignee: ROVI GUIDES, INC., Santa Clara, CA (US)

(21) Appl. No.: 14/710,082

(22) Filed: May 12, 2015

(51) Int. Cl. H04N 21/466; H04N 21/4722; H04N 21/81; H04N 21/482

(52) U.S. Cl. CPC H04N 21/4668; H04N 21/4826; H04N 21/4722; H04N 21/4667; H04N 21/8133

(57) ABSTRACT

Methods and systems are provided for a media guidance application that quickly allows a user to locate content of interest appearing in a media asset. Moreover, the media guidance application may compensate for any delay of the user in indicating an interest in content as the content in presented in a media asset. For example, in response to detecting a user may be interested in content (e.g., an advertisement, a product, a topic, etc.) recently appearing in a media asset, the media guidance application may generate for display recommendations for content recently appearing in the media asset.

### BACKGROUND

The proliferation of platforms and devices capable of playing media content has enabled users to consume video while performing activities in and outside of the home. A user may not be able to devote their full attention to the video being presented, and as a result, may not be able to immediately respond to a content of interest mentioned during the course of the playback of the video. If the user fails to mentally note the name or location of the content of interest, the user is then faced with having to rewind the video in order to re-watch the relevant portion of the video.

### SUMMARY

Methods and systems are provided herein for a media guidance application that quickly allows a user to locate content of interest appearing in a media asset. Moreover, the media guidance application may compensate for any delay of the user in indicating an interest in content as the content is presented in a media asset. For example, in response to detecting that a user may be interested in content (e.g., an advertisement, a product, a topic, etc.) recently appearing in a media asset, the media guidance application may generate for display recommendations for content recently appearing in the media asset.

In some aspects, control circuitry, upon which a media guidance application is implemented, may generate for display, on a display device, a media asset, in which the media asset includes a plurality of instances. For example, the control circuitry may cause a video (e.g., composed of a series of frames) to begin playback. During playback, the control circuitry may receive a user request for a supplemental media asset corresponding to a previously viewed instance in the video. For example, the control circuitry may receive a user request for additional information about a portion of the media asset during a particular frame of the video. For example, the control circuitry may have presented an advertisement for an upcoming show (e.g., “Ground Floor”). Twenty seconds after the advertisement concludes, the control circuitry may receive a user input requesting to perform an action (e.g., schedule a recording).

The control circuitry may then identify a subset of the plurality of instances that occurred within a predetermined period of time of the first instance, in which the subset includes a second instance of the plurality of instances. For example, in order to automatically associate content (e.g., the advertisement discussed above), thus relieving the user from the burden of further inputs in identifying the content, the control circuitry may identify instances in the video that occurred within a predetermined period of time (e.g., thirty seconds) of the instance of the user request. In some embodiments, the predetermined period of time may be user-defined or may be automatically determined by the control circuitry based how long a user typically takes to make a user request after viewing interesting content.

The control circuitry may then cross-reference the second instance with a database listing supplemental media assets that correspond to the plurality of instances to identify a supplemental media asset corresponding to the second instance. For example, the control circuitry may analyze each of the instances of the video during the predetermined period of time for content that could be associated with the user request. Accordingly, the control circuitry may determine that one of the instances during the predetermined thirty seconds of playback corresponds to an upcoming show (e.g., “Ground Floor”).

The control circuitry may then generate for display, on the display device, a recommendation for the supplemental media asset corresponding to the second instance. For example, in response to determining that one of the instances during the predetermined thirty seconds of playback corresponds to the upcoming show, the control circuitry may determine that the likelihood that the user request corresponds to the upcoming show is high. Consequently, the control circuitry may generate a recommendation for the upcoming show.

In some embodiments, the control circuitry may customize the recommendations displayed to the user. For example, the control circuitry may filter the displayed recommendations based on whether the supplemental media assets corresponding to the identified instances correspond to a user profile. For example, the control circuitry may compare an attribute of a supplemental media asset (e.g., a genre) with an attribute (e.g., a genre preference) stored in the user profile. If the attributes corresponds, the control circuitry may generate for display a corresponding recommendation.

Additionally or alternatively, the control circuitry may order recommendations for multiple supplemental media assets based on a timestamp corresponding to the instances associated with each supplemental media asset. For example, the control circuitry may determine that a first recommended supplemental media asset (e.g., “Ground Floor”) is associated with a timestamp that corresponds to twenty-one seconds before the timestamp of the user request. Likewise, the control circuitry may then determine that a second recommended supplemental media asset (e.g., “NBA Home”) is associated with a timestamp that corresponds to five seconds before the timestamp of the user request. Thus, the control circuitry may determine that the user request was more likely to correspond to the second recommended supplemental media asset, as the timestamp associated with that recommended supplemental media asset was closer in time to the timestamp of the user request. Accordingly, the second recommended supplemental media asset may be featured more prominently in an ordered list of recommendations for supplemental media assets.

Additionally or alternatively, the control circuitry may order recommendations based on a likelihood that the user will select a supplemental media asset corresponding to an instance. For example, the control circuitry may determine that, of recommended supplemental media assets, a user selects recommendations for television dramas more often than recommendations for sporting events. Based on this history, the control circuitry may determine that a user is more likely to select recommendations for television dramas than recommendations for sporting events in the future, and therefore may order the supplemental media assets recommendations for television dramas ahead of recommendations for sporting events.

Additionally or alternatively, the control circuitry may order recommendations based on when the supplemental media asset became available to the user. For example, based on metadata associated with a user profile, the control circuitry may determine that a first supplemental media asset became available to the user two days ago, while a second supplemental media asset has been available to the user for the past two years. The control circuitry may determine that because the second supplemental media asset has been available for a longer time, and thus a user has had more opportunities to access the second supplemental media asset, the user is more likely to want to access the first supplemental media asset. Therefore, the control circuitry may order the first supplemental media asset ahead of the second supplemental media asset.

The control circuitry may use various techniques for identifying supplemental media assets that correspond to instances in the media asset. In some embodiments, the control circuitry may identify the supplemental media asset corresponding to an instance based on data associated with the instance, including metadata, closed captioning, text converted from audio, and recognized text from the video frame. For example, the control circuitry may detect closed captioning data in an instance of a media asset and determine a supplemental media asset that corresponds to the detected closed captioning data.

In some embodiments, the predetermined period of time is based on a user history associated with the user. For example, the user may frequently watch television while performing activities at home. As a result, upon hearing or seeing a fragment of a video associated with a supplemental media asset that the user is interested in, the user may need to stop the activity that they are performing, and then walk over to a remote control to pause playback in order to find out more about the media asset. In this scenario, it may take the user twenty-five seconds from the time the supplemental media asset is mentioned in the video to the time that the user sends a request for the supplemental media asset of interest. Based on a history of the user's interaction with the device, control circuitry may determine that the user is frequently interested in supplemental media assets referenced, on average, twenty-five seconds before the time of the corresponding user request. In effect, control circuitry may set the predetermined period of time to be thirty-five seconds, so as to ensure that whenever the user takes longer than the average time of twenty-five seconds to send a request, the supplemental media assets corresponding to the instances that the user is interested can still be identified and recommended.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a display screen generated by a media guidance application in accordance with some embodiments of the disclosure;

FIG. 2 shows another illustrative example of a display screen generated by a media guidance application in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 shows an illustrative embodiment of a display screen showing a media asset at an instance corresponding to an advertisement for a supplemental media asset;

FIG. 6 shows an illustrative embodiment of a display screen showing recommendations for supplemental media assets in accordance with some embodiments of the disclosure;

FIG. 7 is a flowchart of illustrative steps for displaying supplemental media asset recommendations in accordance with some embodiments of the disclosure; and

FIG. 8 is a flowchart of illustrative steps for selecting supplemental media assets for recommendation in accordance with some embodiments of the disclosure.

### DETAILED DESCRIPTION

Methods and systems are provided herein for a media guidance application that quickly allows a user to locate content of interest appearing in a media asset. Moreover, the media guidance application may compensate for any delay of the user in indicating an interest in content as the content is presented in a media asset. For example, in response to detecting that a user may be interested in content (e.g., an advertisement, a product, a topic, etc.) recently appearing in a media asset, the media guidance application may generate for display recommendations for content recently appearing in the media asset.

In some aspects, control circuitry, upon which a media guidance application is implemented, may generate for display, on a display device, a media asset, in which the media asset includes a plurality of instances. For example, the control circuitry may cause a video (e.g., composed of a series of frames) to begin playback. During playback, the control circuitry may receive a user request for a supplemental media asset corresponding to a previously viewed instance in the video. For example, the control circuitry may receive a user request for additional information about a portion of the media asset during a particular frame of the video. For example, the control circuitry may have presented an advertisement for an upcoming show (e.g., “Ground Floor”). Twenty seconds after the advertisement concludes, the control circuitry may receive a user input requesting to perform an action (e.g., schedule a recording).

As used herein, the term “instance” should be understood to correspond to a portion of a media asset occurring a particular moment in time. For example, an instance may correspond to a particular timestamp, frame, or scene, and/or any other unit of the play length of a media asset. For example, an instance may be defined as a value of twenty minutes, ten seconds, or five milliseconds that is measured from the beginning of a media asset playback. It should be noted that video frames, audio data, and metadata may be associated with a specific instance.

The amount of content available to users in any given content delivery system can be substantial. Consequently, many users desire a form of media guidance through an interface that allows users to efficiently navigate content selections and easily identify content that they may desire. An application that provides such guidance, and which may be implemented on control circuitry, is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content.

As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

As used herein, the term “supplemental media asset” refers to any media asset that supplements another asset. For example, a supplemental media asset may include additional information, features, and/or actions associated with another media asset and/or a portion of another media asset. For example, the control circuitry may generate for display a media asset (e.g., “Ground Floor”) of a specific genre (e.g., comedy), type, (e.g., television series), or network affiliation (e.g., “TBS”). In response to a user request, the control circuitry may select a supplemental media asset by identifying a media asset that is associated with an instance of a currently viewed media asset by one of genre, (e.g., comedy), type, (e.g., television series), or network affiliation (e.g., “TBS”), and the like. For example, a show (e.g., “Conan”) with a similar network affiliation (e.g., TBS) may be identified as a supplemental asset of the currently viewed media asset (e.g., “Ground Floor”).

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

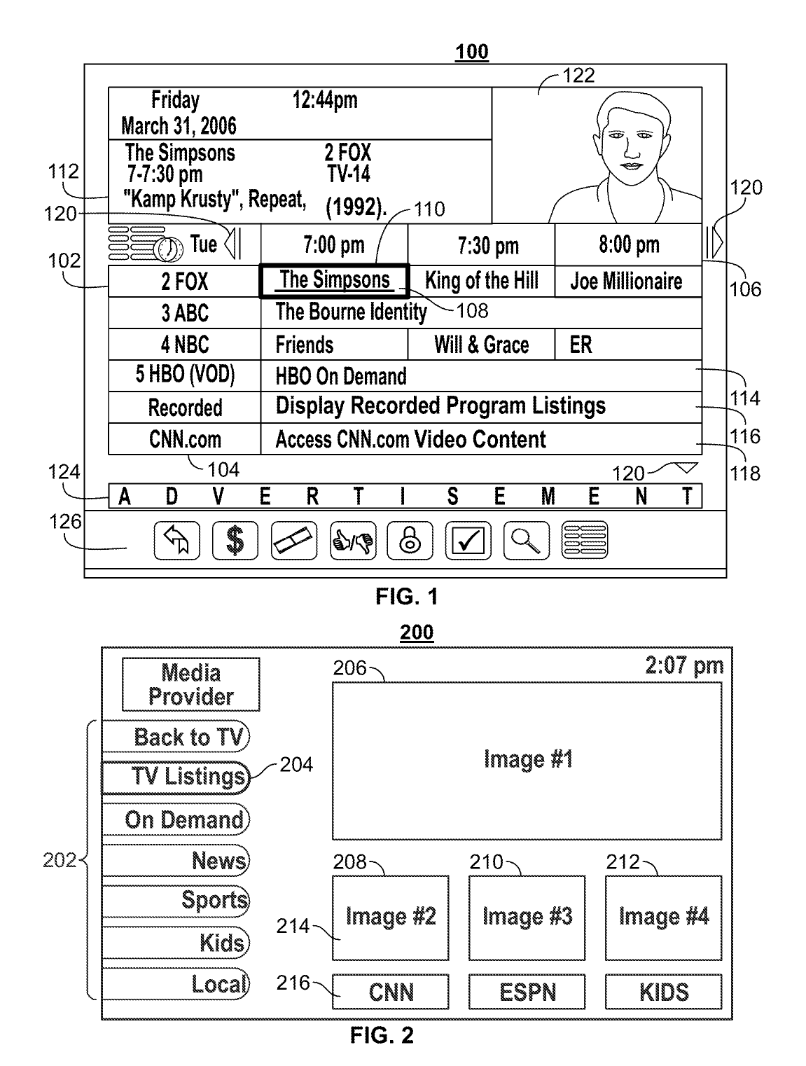

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

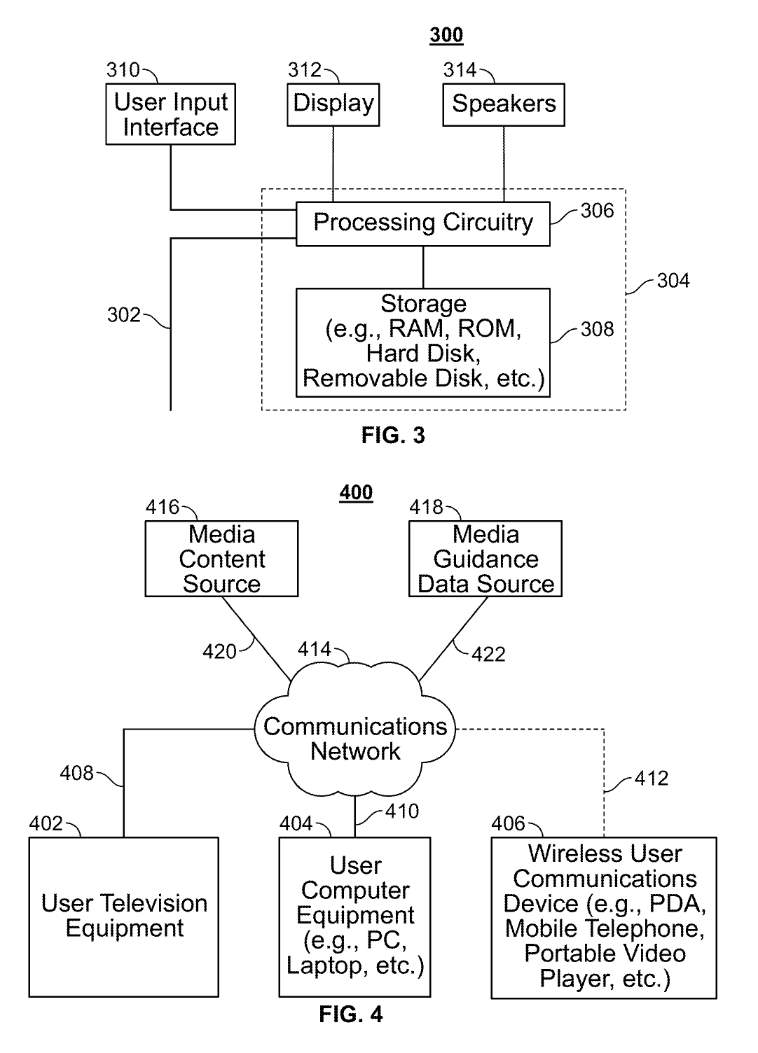

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, and wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

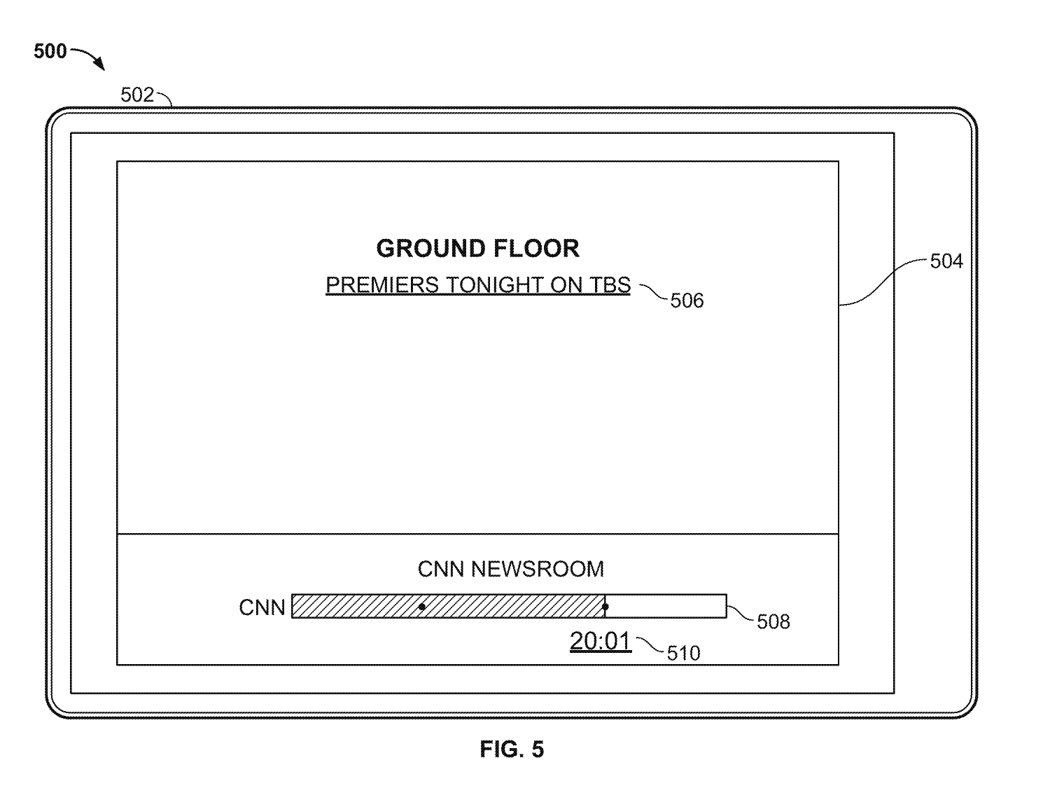

FIG. 5 shows an illustrative embodiment of display 312 of user equipment 502 showing media asset 504 at an instance corresponding to an advertisement for a supplemental media asset (e.g., an instance featuring an advertisement or other content related to the supplemental media asset), in accordance with some embodiments of the disclosure. User equipment 502 is depicted as the display 312 of a wireless user communication device 406, but may be any user equipment device, including user computer equipment 404, or user television equipment 402.

In some embodiments, control circuitry 304 may generate for display, on display 312, a media asset 504, wherein the media asset includes a plurality of instances. For example, media asset 504 (e.g. today's edition of “CNN Newsroom”) may be displayed on display 312 of user equipment 502. Media asset 504 may be associated with a plurality of instances. In FIG. 5, media asset 504 is portrayed by a media frame of the media asset corresponding to time 510 corresponding to the second instance occurring after twenty minutes and one second as measured from the start of media asset 504 playback. Media asset 504 may include an instance corresponding to every second of playback of media asset 504. For example, media asset 504 may be thirty minutes in length, and each second of media asset 504 corresponds to an instance of the media asset. In another example, each instance of media asset 504 may correspond to a five-second interval. As will become more apparent below, an instance of media asset 504 may be associated with advertisement 506 for a supplemental media asset (e.g. an upcoming show, “Ground Floor”).

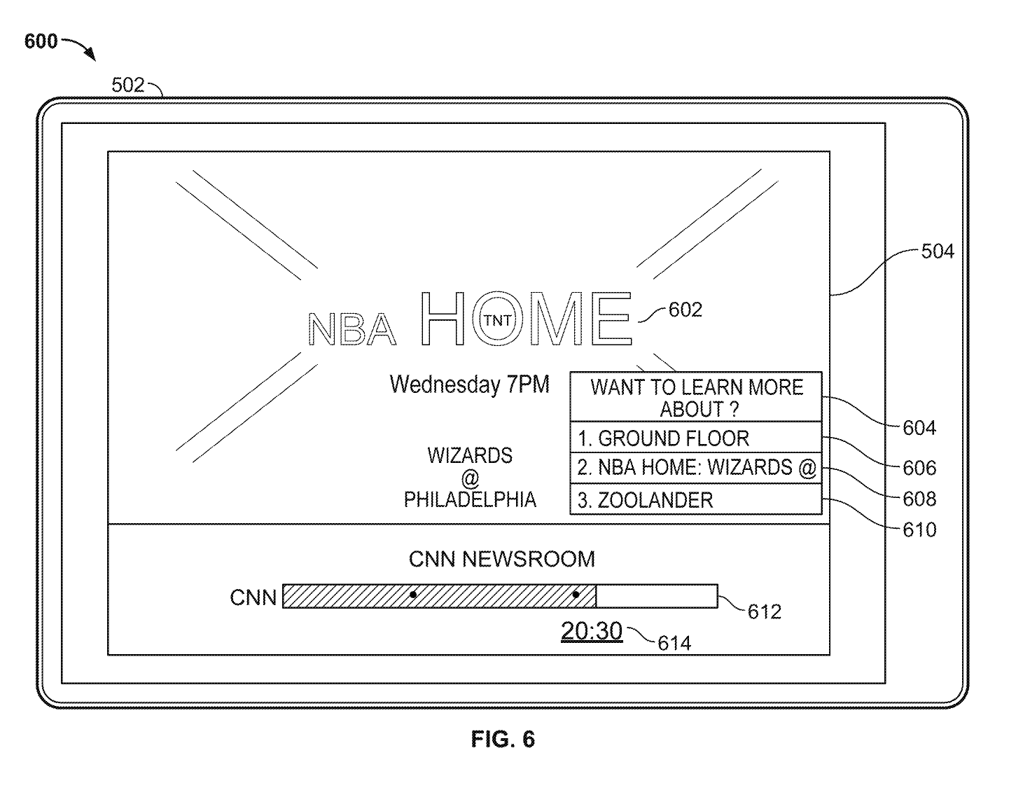

FIG. 6 shows an illustrative embodiment of a display screen showing recommendations for supplemental media assets in accordance with some embodiments of the disclosure. User equipment 502 is depicted as the display 312 of a wireless user communication device 406, but may be any user equipment device, including user computer equipment 404, or user television equipment 402.

In some embodiments, control circuitry 304 may receive, at a first instance of the plurality of instances, a user request for a supplemental media asset associated with advertisement 506 corresponding to a previous instance of the plurality of instances. For example, at a time 510 corresponding to the second instance of media asset 504 (e.g., today's edition of “CNN Newsroom”), the user may become interested in the supplemental media asset associated with advertisement 506 (e.g., “Ground Floor”) and may wish to find out more information about the supplemental media asset. The user may be located at a distance from user input interface 310 or may not immediately realize that he or she may be interested in the supplemental media asset associated with advertisement 506 until some time has passed, for example, until time 614 corresponding to a first instance. At a time 614 corresponding to a first instance, which corresponds to a time of twenty minutes and thirty seconds as measured from the start of media asset 504 playback, control circuitry 304 may receive a user request from a user input interface 310 for the supplemental media asset associated with advertisement 506. To transmit the request, a user may press a dedicated button on a user input interface 310 (e.g., a television remote), or select an option in options region 126. In another example, control circuitry 304 may receive the request as a speech command from the user. Control circuitry 304 may then save a timestamp or any other reference identifying the time 614 corresponding to the first instance in storage 308.

In some embodiments, control circuitry 304 may identify a subset of the plurality of instances that occurred within a predetermined period of time of the first instance, wherein the subset includes a second instance of the plurality of instances. As will become more apparent below, control circuitry 304 may establish the value of the predetermined period of time in various manners, such as by determining a user set value for the predetermined period of time, or calculating the predetermined value based on user history. After control circuitry 304 receives the user request at time 614 corresponding first instance, control circuitry 304 may identify a subset of instances that occurred within a predetermined period of thirty seconds of time 614 corresponding to first instance. For example, if the user request is received at an instance corresponding to twenty minutes and thirty seconds from the start of media playback, and control circuitry 304 determines that the predetermined period of time is set to thirty seconds, control circuitry 304 will determine all instances that occurred within the aforementioned thirty seconds. To accomplish this, control circuitry 304 may retrieve video data from storage 308. Control circuitry 304 may be able to identify the visual, audio, and other data corresponding to each instance of the media asset by determining a timestamp associated with the data. In this scenario, control circuitry 304 may filter out all data that does not correspond to the subset by considering the timestamp in each instance. As follows, control circuitry 304 may then identify a second instance of the subset of instances. An example of a second instance may correspond to a time 510 corresponding to the second instance, which occurred twenty minutes and one second after the start of media asset 504 playback.

In some embodiments, control circuitry 304 may cross-reference the second instance with a database that lists supplemental media assets that correspond to the plurality of instances to identify a supplemental media asset corresponding to the second instance. To that end, after identifying a second instance, control circuitry 304 may query a database listing supplemental media assets and corresponding instances located in storage 308 or send a query by way of communications network 414 to media guidance data source 418, which may contain similar information. For example, control circuitry 304 may identify a second instance by a time 510 corresponding to the second instance, which occurred twenty minutes and one second as measured from the beginning of media asset 504 playback. Control circuitry 304 may then transmit the query to media guidance data source 418 using communications network 414, requesting a supplemental media asset that corresponds to the second instance (e.g., the instance corresponding to twenty minutes and one second as measured from the beginning of playback of media asset 504, e.g., today's edition of “CNN Newsroom”). Media guidance data source 418 may in turn query a database in order to cross-reference the second instance with a supplemental media asset. For example, media guidance data source 418 may query records of a database which contain metadata related to the media asset 504 (e.g., today's edition of “CNN Newsroom”). After identifying these records, media guidance data source 418 may identify database records corresponding to a specific instance in the media asset 504. Such metadata may be stored in various manners. In one approach, each record corresponding to media asset 504 may correspond to a specific instance of time. For example, the instance corresponding to twenty minutes and one second as measured from the beginning of playback of media asset 504 may be identified by a distinct record in the database. In a second approach, sets of instances may be identifiable by a single record in the database. For example, all instances occurring between the instance corresponding to nineteen minutes and thirty seconds from the beginning of playback of media asset 504 to the instance corresponding to twenty minutes and ten seconds from the beginning of playback of media asset 504 may be grouped in one record. In this example, such a record may correlate with an advertisement shown in the media asset 504 (e.g., an advertisement for the upcoming show “Ground Floor”). Regardless of the approach used to store the data, a record that identifies a single instance or a set of instances may be associated with metadata identifying the supplemental media asset. Once the supplemental media asset is identified, control circuitry 304 may receive the name of the supplemental media asset, along with any relevant data associated with the supplemental media asset, from media guidance data source 418 by way of communications network 414. In the case in which the database is stored at a location local to the user, control circuitry 304 may retrieve the name of the supplemental media asset from storage 308.

In some embodiments, control circuitry 304 may identify a subset of the plurality of instances that occurred within a predetermined period of time of a moment of time associated with a frame of the media asset 504. Control circuitry 304 may identify this subset at each instance in which control circuitry 304 displays a media asset frame on display 312. Control circuitry 304 may then identify a second instance of the plurality of instances, and then cross-reference the second instance with a database to identify a supplemental media asset corresponding to the second instance, as previously described. Control circuitry 304 may use a buffer to store a reference to the supplemental media asset corresponding to the second instance. As used herein, a buffer may be a data structure stored in storage 308, and may contain a listing of supplemental media assets references that are relevant to instances that occurred within a predetermined period of time. A reference may identify a supplemental media asset record in media guidance source 418. For example, at each instance associated with media asset 504, control circuitry 304 may determine a supplemental media asset corresponding to a second instance. Control circuitry 304 may cross-reference the supplemental media asset to determine whether control circuitry 304 previously added the reference to the supplemental media asset to the buffer. If control circuitry 304 determines that the supplemental media asset reference is not present in the buffer, control circuitry 304 may proceed to add the reference to the supplemental media asset to the buffer. Concurrently, control circuitry 304 may perform a check to determine whether a supplemental media asset associated with a reference present in the buffer no longer corresponds to an instance that occurred within a predetermined period of time from a moment of time associated with a frame of the media asset currently displayed on display 312. Should control circuitry 304 determine this to be the case, control circuitry 304 may delete the reference to the supplemental media asset from the buffer.

In some embodiments, control circuitry 304 may generate for display, on the display 312 of user equipment 502, a recommendation for the supplemental media asset corresponding to the second instance. For example, once the name of the supplemental media asset is retrieved from storage 308, control circuitry 304 may display the name of the supplemental media asset in a designated area of display 312 of user equipment 502, such as under panel 604 (e.g., “Want to Learn More About?”) overlaid on the display 312 of user equipment 502. Control circuitry 304 may generate a number of recommendations in the same instance. The number of recommendations may be limited by user preference, screen space, and the like.

In some embodiments, control circuitry 304 may filter the first supplemental media asset recommendation 606 based on whether the supplemental media asset associated with time 510 corresponding to the second instance corresponds to a user profile. A user profile may be stored, for example, in storage 308, and may contain viewing history, user interests and preferences, history of the user's interaction with recommendations, and the like. For example, control circuitry 304 may compare an attribute of the supplemental media asset corresponding to the genre with a genre preference attribute stored in the user profile. A genre preference attribute may indicate the types of media genres that the user is most interested in watching. For example, control circuitry 304 may determine that a first supplemental media asset recommendation 606 (e.g., “Ground Floor”) is associated with a genre attribute which is set to “comedy.” Control circuitry 304 may also determine that another supplemental media asset (e.g., “Teen Titans Go”) is associated with a genre attribute which is set to “kids.” Furthermore, control circuitry 304 may determine that the user's profile contains a genre preference attribute that indicates that the user is interested in the “comedy” genre, and that the genre preference attribute does not list the “kids” genre. Therefore, when displaying the recommended supplemental media assets for display, control circuitry 304 will recommend the first supplemental media asset (e.g., “Ground Floor”), but will not recommend the second supplemental media asset (e.g., “Teen Titans Go”). As a second example, control circuitry 304 may additionally determine that a second supplemental media asset recommendation 608 (e.g., “NBA Home”) is associated with a genre attribute which is set to “sports.” Control circuitry 304 may then analyze the user's viewing habits stored in the user profile and determine that the user has seen a substantial number of shows associated with a “sports” genre attribute. Control circuitry 304 may then display a second supplemental media asset recommendation 608 (e.g., “NBA Home”) in addition to the first supplemental media asset recommendation 606 (e.g., “Ground Floor”).

In some embodiments, control circuitry 304 may analyze the user profile and determine whether the user has acted on a previously generated recommendation of a similar type (e.g., similar genre, subject matter, etc.). For example, if a given supplemental media asset had been previously presented for recommendation, and the user had not acted on the recommendation for this particular supplemental media asset, the supplemental media asset (or a supplemental media asset of a similar type) may not be recommended in the future. In such a way, a supplemental media asset (or a supplemental media asset of a similar type) that is mentioned frequently in advertisements may be eliminated from the list of recommendations when control circuitry 304 determines that the user is not interested in the particular supplemental media asset (e.g., has repeatedly not selected the corresponding recommendation). In a different example, if a user had acted on a recommendation for a supplemental media asset by selecting or otherwise performing an action (e.g., scheduling a reminder or recording, adding the supplemental media asset to a favorites list, sharing the supplemental media asset, etc.) with respect to the supplemental media asset, control circuitry 304 may determine that the recommendation should be repeated.

In some embodiments, control circuitry 304 may order recommendations for multiple supplemental media assets based on a timestamp corresponding to the instances associated with each supplemental media asset. For example, control circuitry 304 may associated a timestamp with each instance of the media asset. Thus, each frame or time mark in the media asset may be associated with a unique timestamp. For example, control circuitry 304 may determine that a first supplemental media asset recommendation 606 (e.g., “Ground Floor”) is associated with a timestamp that corresponds to the beginning of the predetermined period of time used for selecting instances of the video, and was displayed exactly twenty-nine seconds before the user request. For example, control circuitry 304 may have generated for display content related to the first supplemental media asset on display 312 twenty-nine seconds before the user request. Control circuitry 304 may then determine that a second supplemental media asset recommendation (e.g., “NBA Home”) is associated with a timestamp that corresponds to the end of the predetermined period of time, and was displayed five seconds before the user request. For example, control circuitry 304 may have generated for display content related to the second supplemental media asset on display 312 five seconds before the user request. Control circuitry 304 may then analyze the user's history of selecting supplemental media asset recommendations, which may be stored in the user profile, and determine whether the user has a history of selecting recommendations for supplemental media assets corresponding to a certain timestamp age. A timestamp age may be calculated by determining the amount of time that has passed between the time of the user's request occurring at the first instance, and the time corresponding to the timestamp associated with the supplemental media asset at a second instance. As an example, a user may frequently be watching media while performing tasks around the house. If the user becomes interested in a supplemental media asset being shown on display 312, the user may not immediately be able to react to the media asset, and may need to walk to a user input interface 310 in order to transmit a request for the supplemental media asset. Control circuitry 304 may detect this tendency for the user to select supplemental media asset recommendations associated with older timestamps by analyzing the user profile associated with the user. Thus, as control circuitry 304 may determine that a user may be more likely to indicate interest in a media asset corresponding to an older instance (e.g., the media asset associated with an instance that is shown twenty-nine seconds before the request) rather than an newer instance (e.g., the media asset associated with the instance five seconds ago), a recommendation for the first supplemental media asset recommendation (e.g., “Ground Floor”) may be displayed preceding the recommendation for second supplemental media asset recommendation (e.g., “NBA Home”).

In some embodiments, control circuitry 304 may order recommendations based on a likelihood that the user will select a supplemental media asset corresponding to an instance. For example, control circuitry 304 may determine user preferences based on data stored in a user profile, such as the user viewing history, user interests and preferences, history of the user's interaction with recommendations, and the like. For example, based on a user's history of selecting recommended supplemental media assets, control circuitry 304 may assign a preference value to each supplemental media asset available for recommending. A preference value may reflect the likelihood that the user will select a given supplemental media asset, and control circuitry 304 may calculate each supplemental media asset's preference value based on the attributes associated with each supplemental media asset as well as data from the user profile. A supplemental media asset associated with a higher preference value may be more likely to be selected by the user than one that is associated with a lower preference value. For example, control circuitry 304 may determine that a first supplemental media asset recommendation 606 corresponding to an upcoming show (e.g., “Ground Floor”) is associated with a higher preference value than a second supplemental media asset recommendation 608 corresponding to an upcoming sports game (e.g., “NBA Home”). In effect, control circuitry 304 may order the recommended supplemental media assets by displaying the first supplemental media asset recommendation 606 corresponding to the upcoming show (e.g., “Ground Floor”) before the second supplemental media asset recommendation 608 corresponding to an upcoming sports game (e.g., “NBA Home”).

In some embodiments, control circuitry 304 may order recommendations based on when the supplemental media asset became available to the user. For example, based on attributes stored in the user's profile, control circuitry 304 may determine that a first supplemental media asset recommendation 606 corresponding to the first episode of an upcoming show (e.g., “Ground Floor”) become available to the user two days ago, while a third supplemental media asset recommendation 610 corresponding to an movie (e.g., “Zoolander”) had been available in the user's Video-On-Demand selection for the past two years. Therefore, control circuitry 304 may order the recommended supplemental media assets by displaying the first supplemental media asset recommendation 606 corresponding to the upcoming show (e.g., “Ground Floor”) ahead of third supplemental media asset recommendation 610 corresponding to the movie (e.g., “Zoolander”). If a supplemental media asset is not yet available, control circuitry 304 may prioritize the recommendation of such an asset with respect to a supplemental media asset that is already available to the user. For example, if control circuitry 304 determines that a supplemental media asset corresponding 608 to an upcoming sports game (e.g., “NBA Home”) has yet to air, control circuitry 304 may prioritize the recommendation of that supplemental media asset so that it is displayed before the recommendation for a supplemental media asset that is available at the time of the user's request (e.g., “Zoolander”).

In some embodiments, control circuitry 304 may identify the supplemental media asset corresponding to an instance based on data associated with the instance, including metadata, closed captioning, text converted from audio, and recognized text from the video frame.

### EXAMPLE 1

Each instance associated with a displayed media asset may be associated with metadata, which may be identifiable by media asset name and timestamp. Metadata may describe supplemental media assets associated with the instance, actors and characters appearing in the instance, a visual content of the instance, and the like. As an example, a database of metadata associated with a media asset may be available in media guidance data source 418. Control circuitry 304 may transmit a query over communications network 414 to media guidance data source 418, requesting available metadata corresponding to a specific instance in a media asset. For example, control circuitry 304 may transmit a query to media guidance data source 418 requesting metadata corresponding to the timestamp twenty minutes and thirty seconds from the start of playback of media asset 502 (e.g., today's episode of “CNN Newsroom”). Media guidance data source 418 may return a set of metadata corresponding to the instance, which may indicate a supplemental media asset (e.g., “NBA Home) corresponding to the instance.

### EXAMPLE 2

Each instance associated with a displayed media asset may be associated with closed captioning text. Control circuitry 304 may monitor the closed captioning text associated with each instance to determine whether the closed captioning text contains a reference to a supplemental media asset. For example, a user may be viewing a talk show segment, during which an upcoming show (e.g., “Ground Floor”) is named and discussed. The closed captioning text that is associated with each instance of the talk show segment may contain the name of the upcoming show; furthermore, the instance at which the upcoming show is discussed may be associated with the particular fragment of the closed captioning text in which the name of the upcoming show is contained. Control circuitry 304 may then identify the first supplemental media asset recommendation 606 by correlating the name of the upcoming show with the corresponding instance.

### EXAMPLE 3

When the instances of a media asset are not associated with accessible data, such as metadata or closed captioning data, control circuitry 304 may utilize speech conversion or text recognition to determine a supplemental media asset. For example, control circuitry 304 may utilize speech recognition algorithms to generate an audio transcript corresponding to the audio track of the media asset. Control circuitry 304 may then proceed to associate each instance of the media asset with segments of the transcript, and identify those instances that contain a name of a supplemental media asset. In another example, control circuitry 304 may utilize text recognition. For example, control circuitry 304 may use text recognition algorithms to analyze each relevant media frame of the media asset. For example, at an instance corresponding to twenty minutes and thirty seconds as measured from the beginning of playback of media asset 502 (e.g., today's edition of “CNN Newsroom”), control circuitry 304 may analyze text contained in the video frame and determine that text fragments “NBA,” “Wednesday 7 PM,” and “Wizards @ Philadelphia” are present in the video frame. Control circuitry 304 may further attempt to cross-reference each text fragment with data in media guidance data source 418 to determine whether any of the text fragments correspond to content associated with a supplemental media asset. For example, control circuitry 304 may determine that text fragment “NBA” corresponds to advertisement 602, which advertises a second supplemental media asset (e.g., “NBA Home”) based on the data in media guidance data source 418.

In some embodiments, control circuitry 304 may generate for display another recommendation for a supplemental media asset corresponding to another instance of the media asset being displayed. For example, in addition to a recommendation for an upcoming show, (e.g., “Ground Floor”), which may correspond to the instances associated with the first ten seconds of a predetermined thirty-second period of time, control circuitry 304 may generate for display a recommendation for an upcoming movie (e.g., “Zoolander”), which may correspond to the instances associated with the middle ten seconds of the predetermined thirty-second period of time. Control circuitry 304 may generate further recommendations. The number of recommendations may be limited by the amount of available screen space on display 312 for displaying recommendations or by a user-defined setting which may define the maximum number of recommendations to display.

In some embodiments, control circuitry 304 may generate for display, on the display device, an option to perform an action corresponding to the supplemental media asset. The actions available for each media asset may be determined by using a plugin, which may be comprised of software designed to communicate with media guidance data source 418 for determining the available actions that may be performed on a supplemental media asset. Such actions may include playing, recording, adding to a watch list, displaying more information, searching the Internet, and setting a reminder. For example, when control circuitry 304 identifies the first supplemental media asset recommendation 606 corresponding to an upcoming show (e.g., “Ground Floor), control circuitry 304 may display the supplemental media asset recommendation 606. In addition, control circuitry 304 may display an action corresponding to the identified supplemental media asset. For example, in response to a user selection of the recommendation by way of user input interface 310, control circuitry 304 may display an option to record the supplemental media asset corresponding to the upcoming show (e.g., “Ground Floor) when the supplemental media asset is scheduled to air. Control circuitry 304 may determine the air time by searching a media guidance data source 418 for an instance of the upcoming show. Control circuitry 304 may also determine a URL associated with the supplemental media asset, and provide an option to open a browser session using the specified URL.

In some embodiments, control circuitry 304 may present an option with each supplemental media asset to avoid recommending a supplemental media asset in the future. For example, if a user is not interested in a particular type of show, the user may select the recommendation and select a “Do not recommend this again” option. Control circuitry 304 may save the user's preference in the user profile so that the recommendation for that particular supplemental media asset is not generated in the future.

In some embodiments, control circuitry 304 may base the predetermined period of time on a user history associated with the user. For example, the user may frequently watch television while performing activities in their home. As a result, upon hearing or seeing a fragment of a video associated with a supplemental media asset that the user is interested in, the user may need to stop the activity that they are performing, and then walk over to a remote control to pause playback in order to find out more about the media asset. In this scenario, it may take the user twenty-five seconds from the time the media asset is mentioned in the video to the time that the user sends a request for the media asset of interest. Based on a history of the user's interaction with the device, control circuitry 304 may determine that the user is frequently interested in media assets referenced, on average, twenty-five seconds before the time of the request. In effect, control circuitry 304 may set the predetermined period of time to be at thirty-five seconds, to ensure that whenever the user takes longer than the average time of twenty-five seconds to send a request, the supplemental media assets corresponding to the instances in which the user is interested are still identified and recommended.

In some embodiments, control circuitry 304 may base the predetermined period of time on a user-defined variable. For example, if the user is aware that they are able to quickly send a request for a supplemental media asset, the user may set the predetermined period of time to five seconds, so that supplemental media assets corresponding to instances that occurred more than five seconds before the user sends a request are not displayed.

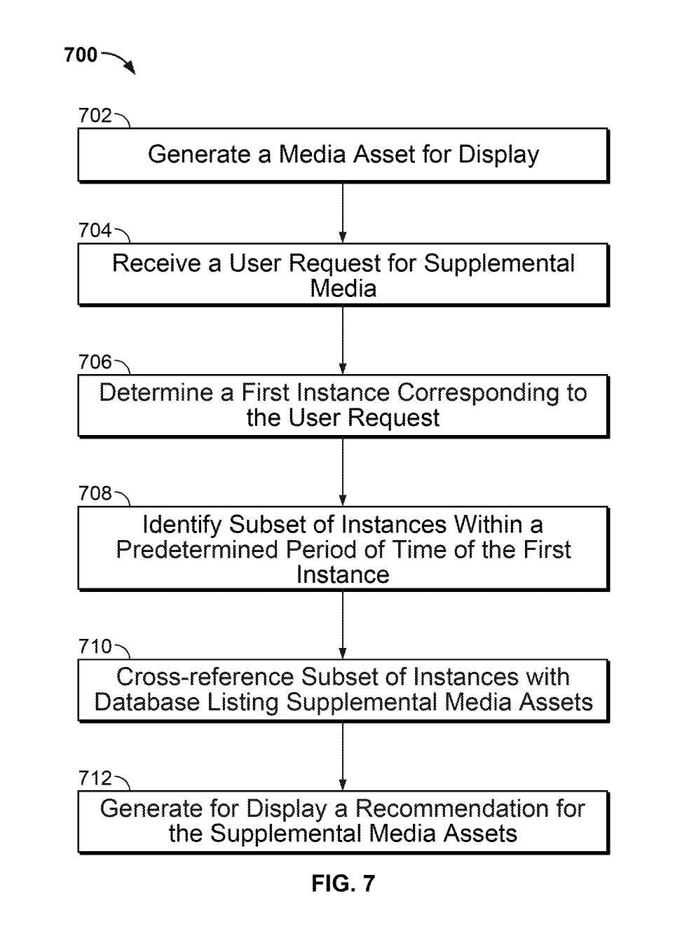

FIG. 7 is a flowchart of illustrative steps involved in displaying supplemental media asset recommendations in accordance with some embodiments of the disclosure. It should be noted that process 700 or any step thereof could be performed on, or provided by, any of the devices shown in FIGS. 3-6. For example, process 700 may be executed by control circuitry 304 (FIG. 3) as instructed by control circuitry implemented on user equipment 402, 404, and/or 406 (FIG. 4) in order to display supplemental media asset recommendations. In addition, one or more steps of process 700 may be incorporated into or combined with one or more steps of any other process or embodiment.

Process 700 begins at step 702, where control circuitry 304 generates media asset 504 for display on display 312 of user equipment 502. Media asset 504 is, for example, broadcast television video, Internet video, on-demand video, or video from any other source. For example, control circuitry 304 displays a media asset 504 (e.g., today's edition of “CNN Newsroom”). User equipment 502 is depicted as a tablet device, but may be any user equipment device, including user television equipment 402, user computer equipment 404, or wireless user communication device 406. Advertisement 506 for a supplemental media asset is displayed at time 510 corresponding to the second instance (e.g., twenty minutes and one second from the start of playback of media asset 504).

At step 704, control circuitry 304 receives a user request for a supplemental media asset. Control circuitry 304 receives the user request by detecting a user pressing a dedicated button on a user input interface 310 (e.g., a television remote), or the user selecting an option in options region 126. In another example, control circuitry 304 receives the request as a speech command from the user.

At step 706, control circuitry 304 determines a first instance corresponding to the user request. For example, control circuitry 304 saves a timestamp identifying a time 614 corresponding to a first instance in storage 308 corresponding to the time of the user request.

At step 708, control circuitry 304 identifies a subset of instances within a predetermined period of time of the first instance. For example, if the user request is received at an instance corresponding to twenty minutes and thirty seconds from the start of media playback, and control circuitry 304 determines that the predetermined period of time is set to thirty seconds, control circuitry 304 will determine all instances that occurred within the aforementioned thirty seconds. To accomplish this, control circuitry 304 retrieves the video data from storage 308. Control circuitry 304 identifies the visual, audio, or other data corresponding to each instance of the media asset by determining a timestamp associated with the data. In this scenario, control circuitry 304 filters out all data that does not correspond to the subset by considering the timestamp in each instance. As follows, control circuitry 304 then identifies a second instance of the subset of instances, for example, the instance corresponding to a time 510, which occurred twenty minutes and one second after the start of media asset 504 playback.

At step 710, control circuitry 304 cross-references the subset of instances with a database listing supplemental media assets. A database is located, for example, in storage 308 or in media guidance data source 418. To cross-reference the subset of instances, control circuitry 304 queries a database listing supplemental media assets and corresponding instances located in storage 308 or sends a query by way of communications network 414 to media guidance data source 418, which contains similar information. For example, control circuitry 304 identifies a second instance at a time 510 corresponding to the second instance, which occurred twenty minutes and one second as measured from the beginning of media asset 504 playback. Control circuitry 304 then transmits the query to media guidance data source 418 using communications network 414, requesting a supplemental media asset that corresponds to the second instance (e.g., the instance corresponding to twenty minutes and one second as measured from the beginning of playback of media asset 504, today's edition of “CNN Newsroom”). Media guidance data source 418 in turn queries a database in order to cross-reference the second instance to identify records which contain metadata related to the media asset 504 (e.g., today's edition of “CNN Newsroom). After identifying these records, media guidance data source 418 identifies database records corresponding to the specific instance in the media asset 504. A record that identifies a single instance or a set of instances is associated with metadata identifying the media asset. For example, one type of database record correlates to all instances occurring between the instance corresponding to nineteen minutes and thirty seconds from the beginning of playback of media asset 504 to the instance corresponding to twenty minutes and ten seconds from the beginning of playback of media asset 504 to a supplemental media asset (e.g., “Ground Floor”). Once the supplemental media asset is identified, control circuitry 304 receives the name of the supplemental media asset, along with any relevant data associated with the supplemental media asset, from media guidance data source 418 by way of communications network 414. In the case in which the database is available in storage 308, control circuitry 304 retrieves the name of the supplemental media asset.

At step 712, control circuitry 304 generates for display a recommendation for the supplemental media asset. For example, once the name of the supplemental media asset is retrieved from storage 308, control circuitry 304 displays the name of the supplemental media asset in a designated area of display 312 of user equipment 502, such as under panel 604 (e.g., “Want to Learn More About?”) overlaid on display 312 of user equipment 502.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method.

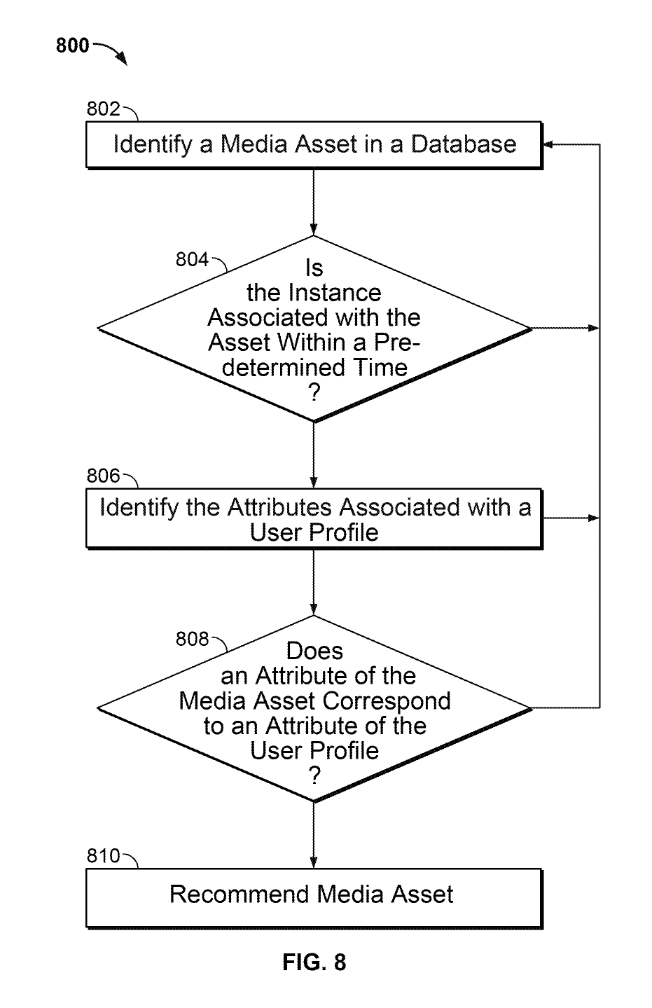

FIG. 8 is a flowchart of illustrative steps for selecting supplemental media assets for recommendation in accordance with some embodiments of the disclosure. It should be noted that process 800 or any step thereof could be performed on, or provided by, any of the devices shown in FIGS. 3-5. For example, process 800 may be executed by control circuitry 304 (FIG. 3) as instructed by control circuitry implemented on user equipment 402, 404, and/or 406 (FIG. 4) in order to select supplemental media assets for recommendation. In addition, one or more steps of process 800 may be incorporated into or combined with one or more steps of any other process or embodiment.

At step 802, control circuitry 304 identifies a media asset in a database. A database may be located, for example, in storage 308 or in media guidance data source 418. For example, control circuitry 304 transmits a query to media guidance data source 418 in order to identify supplementary media asset associated with an instance. For example, when a database record correlates to a specific instance occurring twenty minutes and ten seconds from the beginning of playback of media asset 504, the record lists a supplemental media asset (e.g., “Ground Floor”) associated with the instance. Once the supplemental media asset is identified, control circuitry 304 receives the name of the supplemental media asset, along with any relevant data associated with the supplemental media asset, from media guidance data source 418 by way of communications network 414. In the case in which the database is available in storage 308, control circuitry 304 retrieves the name of the supplemental media asset.

At step 804, control circuitry 304 determines whether the instance associated with the asset occurred within a predetermined period of time. Control circuitry 304 establishes the value of the predetermined period of time in various manners, such as by determining a user set value for the predetermined period of time, or calculating the predetermined value based on user history. Control circuitry 304 then determines whether the instance associated with the identified supplemental media asset is within the predetermined period of time. For example, the instance associated with the supplemental media asset corresponds to the time twenty minutes and ten seconds from the beginning of playback of media asset 504, which is within thirty seconds of the time 614 corresponding to first instance.

If control circuitry 304 determines that the instance associated with the supplemental media asset is within a pre-determined time, process 800 continues to step 806. At step 806, control circuitry 304 identifies an attribute associated with a user profile. For example, control circuitry 304 determines that the user's profile contains a genre preference attribute that indicates that the user is interested in the “comedy” genre.

At step 808, control circuitry 304 determines whether an attribute of the media asset corresponds to an attribute of the user profile. For example, control circuitry 304 determines that a supplemental media asset (e.g., “Ground Floor”) is associated with a genre attribute which is set to “comedy.” Control circuitry determines that this attribute matches the genre preference attribute of the user profile.

If control circuitry 304 determines that an attribute of the media asset corresponds to an attribute of the user profile, process 800 continues to step 810. At step 810, control circuitry 304 selects the asset for recommendation. For example, control circuitry 304 displays the name of the supplemental media asset in a designated area of display 312 of user equipment 502, such as under panel 604 (e.g., “Want to Learn More About?”) overlaid on display 312 of user equipment 502.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes.

It should be noted that processes 700 and 800 or any step thereof could be performed on, or provided by, any of the devices shown in FIGS. 3-4. For example, process 700 may be executed by control circuitry 304 (FIG. 3) as instructed by control circuitry 304 implemented on user equipment 502, 404, and/or 406 (FIG. 4) in order to select supplemental media assets for recommendation.

It is contemplated that the steps or descriptions of FIG. 8 may be used with any other embodiment of this disclosure. In addition, the steps and descriptions described in relation to FIG. 8 may be done in alternative orders or in parallel to further the purposes of this disclosure. For example, each of these steps may be performed in any order or in parallel or substantially simultaneously to reduce lag or increase the speed of the system or method.

It will be apparent to those of ordinary skill in the art that methods involved in the present invention may be embodied in a computer program product that includes a computer-usable and/or readable medium. For example, such a computer-usable medium may consist of a read-only memory device, such as a CD-ROM disk or conventional ROM devices, or a random access memory, such as a hard drive device or a computer diskette, having a computer-readable program code stored thereon. It should also be understood that methods, techniques, and processes involved in the present invention may be executed using processing circuitry. For instance, detection of a social media interaction associated with a user may be performed by processing circuitry, e.g., by processing circuitry 306 of FIG. 3. The processing circuitry, for instance, may be a general purpose processor, a customized integrated circuit (e.g., an ASIC), or a field-programmable gate array (FPGA) within user equipment 300, media content source 416, or media guidance data source 418. For example, the media asset metadata as described herein may be stored in, and retrieved from, storage 308 of FIG. 3, or media guidance data source 418 of FIG. 4. Furthermore, processing circuitry, or a computer program, may update settings associated with a user, such as user profile attributes, updating the information stored within storage 308 of FIG. 3 or media guidance data source 418 of FIG. 4.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for recommending media content to a user during media playback, the method comprising:
generating for display, on a display device, a media asset, wherein the media asset includes a plurality of instances;
receiving, at a first instance of the plurality of instances, a user request for a supplemental media asset corresponding to a previous instance of the plurality of instances;
identifying a subset of the plurality of instances that occurred within a predetermined period of time of the first instance, wherein the subset includes a second instance of the plurality of instances;
cross-referencing the second instance with a database listing supplemental media assets that correspond to the plurality of instances to identify a supplemental media asset corresponding to the second instance;
generating for display, on the display device, a recommendation for the supplemental media asset corresponding to the second instance; and
ordering the recommendation among a plurality of recommendations based on when the supplemental media asset corresponding to the second instance became available to the user in the past.

2. The method of claim 1, further comprising filtering the recommendation based on whether the supplemental media asset corresponding to the second instance corresponds to a user profile.

3. The method of claim 1, wherein ordering the recommendation among a plurality of recommendations is further based on a timestamp corresponding to the second instance.

4. The method of claim 1, wherein ordering the recommendation among a plurality of recommendations is further based on a likelihood that the user will select the supplemental media asset corresponding to the second instance.

5. (canceled)

6. The method of claim 1, further comprising identifying the supplemental media asset corresponding to the second instance based on metadata, closed captioning, text converted from audio, or recognized text corresponding to second instance.

7. The method of claim 1, further comprising generating for display, on the display device, another recommendation for a supplemental media asset corresponding to a third instance of the plurality of instances, wherein the subset includes the third instance.

8. The method of claim 1, further comprising generating for display, on the display device, an option to perform an action corresponding to the supplemental media asset corresponding to the second instance.

9. The method of claim 1, wherein the predetermined period of time is based on a user history associated with the user.

10. The method of claim 1, wherein the predetermined period of time is user-defined.

11. A system for recommending media content to a user during media playback, the system comprising control circuitry configured to:
generate for display, on a display device, a media asset, wherein the media asset includes a plurality of instances;
receive, at a first instance of the plurality of instances, a user request for a supplemental media asset corresponding to a previous instance of the plurality of instances;
identify a subset of the plurality of instances that occurred within a predetermined period of time of the first instance, wherein the subset includes a second instance of the plurality of instances;
cross-reference the second instance with a database listing supplemental media assets that correspond to the plurality of instances to identify a supplemental media asset corresponding to the second instance;
generate for display, on the display device, a recommendation for the supplemental media asset corresponding to the second instance; and
order the recommendation among a plurality of recommendations based on when the supplemental media asset corresponding to the second instance became available to the user in the past.

12. The system of claim 11, wherein the control circuitry is further configured to filter the recommendation based on whether the supplemental media asset corresponding to the second instance corresponds to a user profile.

13. The system of claim 11, wherein ordering the recommendation among a plurality of recommendations is further based on a timestamp corresponding to the second instance.

14. The system of claim 11, wherein ordering the recommendation among a plurality of recommendations is further based on a likelihood that the user will select the supplemental media asset corresponding to the second instance.

15. (canceled)

16. The system of claim 11, wherein the control circuitry is further configured to identify the supplemental media asset corresponding to the second instance based on metadata, closed captioning, text converted from audio, or recognized text corresponding to second instance.

17. The system of claim 11, wherein the control circuitry is further configured to generate on the display device, another recommendation for a supplemental media asset corresponding to a third instance of the plurality of instances, wherein the subset includes the third instance.

18. The system of claim 11, wherein the control circuitry is further configured to generate for display, on the display device, an option to perform an action corresponding to the supplemental media asset corresponding to the second instance.

19. The system of claim 11, wherein the predetermined period of time is based on a user history associated with the user.

20. The system of claim 11, wherein the predetermined period of time is user-defined.

21-50. (canceled)
